(19) United States
(12) Patent Application Publication
(10) Pub. No.: US 2007/0229673 A1
(43) Pub. Date: Oct. 4, 2007

(54) IMAGE CAPTURING APPARATUS

(76) Inventors: Yoshitaka Araya, Chiba (JP); Masanori Sonoi, Kanagawa (JP); Shinichi Yoshida, Kanagawa (JP)

Correspondence Address: Pamela R. Crocker;Patent Legal Staff, Eastman Kodak Company, 343 State Street, Rochester, NY, 14650-2201, US

(21) Appl. No.: 11/533,112

(22) Filed: Sep. 19, 2006

(30) Foreign Application Priority Data
Mar. 31, 2006 (JP) 2006-99423

(51) Int. Cl. H04N 5/225

(52) U.S. Cl. 348/220.1

(57) ABSTRACT

During capture of a motion picture, a still image of high resolution and frame images of a moving mage are formed from one image signal. Each of the frame images is synthesized with a tag image for identifying the frame image. A motion picture is formed from the frame image synthesized with the tag image. Concurrently, data pertaining to a difference between the frame image synthesized with the tag image and the still image are computed, and the difference data are stored in a storage device. The still image is deleted. At this time, an address of difference data and details of the tag image synthesized with the frame image are recorded in an associated manner as index information. When the still image is formed from an arbitrary frame image of the motion picture, the frame image is identified by reference to the tag image, and an identification result is utilized.

### CROSS REFERENCE TO RELATED APPLICATIONS

This application claims priority to Japanese Patent Application No. 2006-99423 filed on Mar. 31, 2006, which is incorporated herein by reference in its entirety.

### BACKGROUND OF THE INVENTION

1. Field of the Invention

The present invention relates to an image capturing apparatus capable of creating a still image of high resolution corresponding to an arbitrary frame image among a plurality of frame images forming a motion picture.

2. Related Art

An image capturing apparatus capable of capturing and recording motion pictures as well as still images has recently been known. In relation to such an image capturing apparatus, the user selects an image desired to be captured; namely, a still image or a motion picture, and performs image-capturing operation. As a matter of course, during capture of motion pictures, capture of still images cannot be performed.

However, there has recently arisen a demand for acquiring one scene of a captured motion picture as a still image of high resolution. The motion picture is formed from a plurality of still images of low resolution called frame images. Another demand has arisen for extracting, as a still image of higher resolution, an image of a subject included in an arbitrary frame image among the frame images constituting the motion picture. Conceivable means for fulfilling the demand is to acquire a still image in conjunction with acquisition of frame images, and to store the thus-acquired images. However, when the still image of high resolution is acquired and stored at a frame rate of a motion picture (e.g., one-thirtieth of a second), the storage capacity required to store the still images becomes enormous. Hence, difficulty is encountered in implementing the acquisition and storage of still images of high resolution at the frame rate of a motion picture.

Japanese Patent Laid-Open Publication No. 2004-200760 describes a technique for acquiring a still image in conjunction with acquisition of a frame image and storing only data pertaining to a difference between the frame image and the still image. Since the volume of the difference data can be significantly reduced as compared with the volume of still image data, storing difference data corresponding to all of frame images does not present any substantial problem. When an image of a subject included in an arbitrary frame image is reproduced as a still image of high resolution, the essential requirement is to perform addition of the frame image to difference data corresponding thereto. Such a technique enables generation of a still image of high resolution from a motion picture.

In order to implement this technique, a correspondence between each of the frame images and difference data must be rigorously managed. Put another way, the capability of individually distinguishing frame images from each other is required. However, an MPEG format widely used for a motion picture encounters difficulty in effecting distinction on a per-frame basis. According to the MPEG format, a GOP is formed from a plurality of frame images, and management is performed on a per-GOP basis. Consequently, the header section is provided for each GOP, but no header section is available on a per-frame basis. The sequence of storage of frames in one GOP performed during MPEG encoding operation does not coincide with the sequence of reproduction, and management on a per-frame basis is made more complicated.

In the case of a motion picture of a format which is difficult to manage on a per-frame basis, difficulty is encountered in generating a still image from a motion picture by utilization of existing difference data.

### SUMMARY OF THE INVENTION

Accordingly, the present invention provides an image capturing apparatus capable of generating a still image from a motion picture by utilization of difference data.

The present invention provides an image capturing apparatus capable of creating a still image of high resolution corresponding to an arbitrary frame image among a plurality of frame images constituting a motion picture, the apparatus comprising;

image forming means for forming, from one image signal, frame images constituting the motion picture and a still image which is higher in resolution than the frame images;

identification image adding means for synthesizing to each of the formed frame images an identification image showing frame identification information used for identifying the frame image;

difference data forming means which acquires data pertaining to a difference between the frame image with which the identification image is synthesized and a still image corresponding to the frame image and which stores the difference data into storage means;

motion picture forming means which forms a motion picture on the basis of the frame image with which an identification image is synthesized, and which stores the motion picture into the storage means; and

still image reconstructing means which specifies difference data corresponding to the specified frame image by reference to at least the frame identification information indicted by the identification image synthesized with the frame image, and which reconstructs a still image of high resolution on the basis of the frame image and the specified difference data.

In a preferred mode, the identification image is a bar code formed by means of converting, into an image, a frame identification number used for identifying each of the frame images in accordance with a predetermined algorithm. The identification image is preferably synthesized with a corner of each of the frame images. Moreover, the identification image is preferably synthesized with the frame image along with another image which is analogous in color to the identification image.

In another preferred mode, the motion picture forming means preferably forms a motion picture in a motion picture format by means of which header information is not added to each frame. More specifically, the motion picture forming means preferably forms a motion picture in an MPEG 2 format.

In another preferred mode, the image capturing apparatus further comprises index information forming means which forms index information for recording in an associated manner at least frame identification information showing an identification image synthesized with each of the frame images and identification information about differential data, wherein

the still image reconstructing means specifies difference data corresponding to the specified frame image by reference to the index information. When a motion picture corresponds to data formed by sequentially arranging frame groups, each of which is formed from a plurality of frame images, index information is preferably information formed by recording in an associated manner frame identification information about a frame group to which each of frame images pertains, frame identification information indicated by an identification image synthesized with the frame image, and an address of difference data corresponding to the frame image.

The present invention also provides an image capturing apparatus for generating a motion picture from a plurality of frame images, the apparatus comprising:

identification image adding means for synthesizing, before a motion picture is subjected to encoding processing, each of frame images constituting a motion picture with an identification image showing frame identification information used for identifying the frame image; and

identification means for identifying each of the frame images in accordance with at least frame identification information showing an identification image synthesized to each of the frame images.

According to the present invention, each of frame images forming a motion picture is synthesized with an identification image showing frame identification information. Consequently, each of the frame images can be identified by interpreting the identification image. Consequently, a still image can be created from a motion picture by utilization of difference data.

The invention will be more clearly comprehended by reference to the embodiments provided below. However, the scope of the invention is not limited to those embodiments.

### BRIEF DESCRIPTION OF THE DRAWINGS

Preferred embodiments of the present invention will be described in detail by reference to the following figures, wherein:

FIG. 1 is a block diagram showing the functional configuration of a digital camera according to an embodiment of the present invention;

FIG. 2 is a flowchart showing the flow of processing performed during capture of a motion picture;

FIG. 3 is a view showing a hierarchical structure of MPEG 2 data;

FIG. 4 is a view showing example synthesis of tag images;

FIG. 5 is a view showing another example synthesis of tag images;

FIG. 6 is a view showing example index information;

FIG. 7 is a flowchart showing the flow of processing performed when a still image is generated from a motion picture; and

FIG. 8 is a flowchart showing another example flow of processing employed during capture of a motion picture.

### DETAILED DESCRIPTION OF THE INVENTION

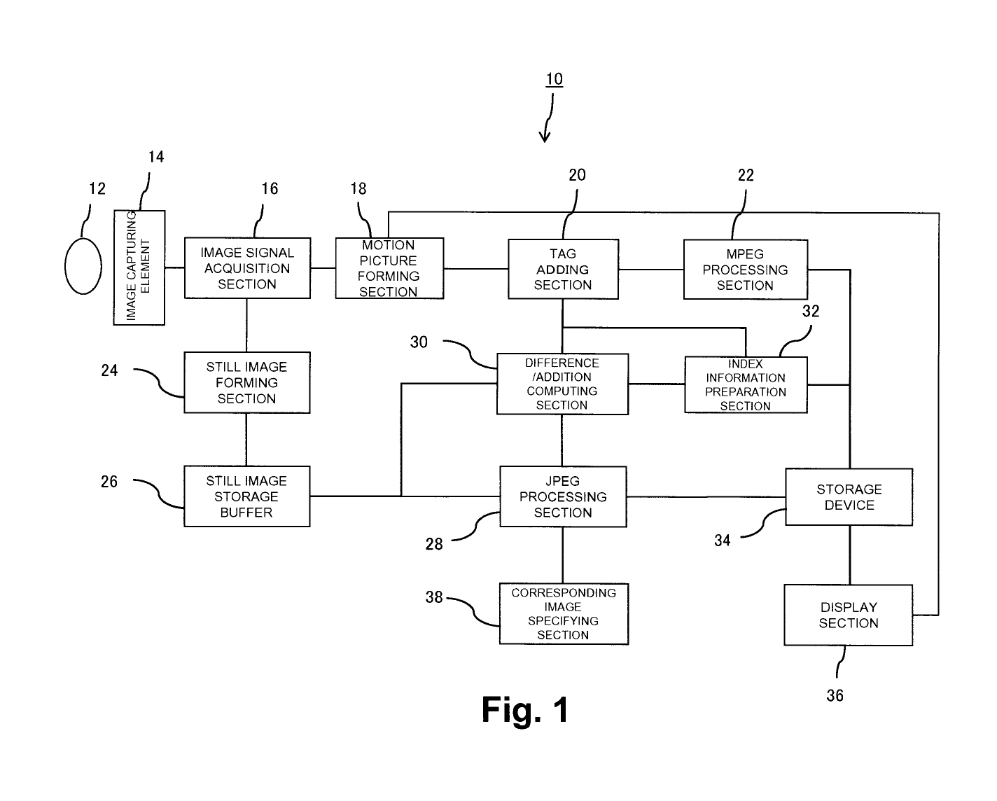

An embodiment of the present invention will be described herein below by reference to the drawings. FIG. 1 is a block diagram showing the functional configuration of a digital camera 10 according to an embodiment of the present invention. This digital camera 10 can handle both a still image and a motion picture. When a motion picture has been captured, a still image of high resolution can be generated from the motion picture, and the thus-generated still image can be output. In the present embodiment, a motion picture and data pertaining to a difference between the motion picture and a still image are stored for the purpose of generating the still image from the motion picture.

Specifically, the motion picture is formed from a plurality of pieces of frame image data which are generated by processing, for use as a motion picture, an image signal read from an image capture element 14 at a predetermined frame rate. During capture of a motion picture, sequentially-read image signals are subjected to still image processing in conjunction with generation of frame image data, thereby acquiring still image data of high resolution. Difference data obtained as a result of computation of a difference between the thus-obtained still image data and the frame image data are memorized and stored along with a motion picture. While viewing a reproduced motion picture, the user specifies a frame desired to be extracted as a still image of high resolution. The camera having received such specification generates, from the frame image data and the difference data, a still image of high resolution corresponding to the frame image data, and outputs the still image of high resolution.

Processing for generating a still image from a motion picture requires accurate management of a correspondence between each of pieces of the frame image data and difference data. In order to manage a correspondence between the frame image data and the difference data, a tag-adding section 20, which will be described later, and an index information preparation section 32 are provided in the present embodiment. The functional configuration of the digital camera 10 will be described herein below.

As in the case of an ordinary camera, an image capture optical system 12 is formed from a zoom lens, an aperture, a shutter assembly, and the like. The image of the subject is formed on the image capture element 14 by means of the image capture optical system 12. The image capture element 14 subjects the thus-formed image of the subject to photoelectric conversion, and accumulates the thus-converted signals as a charge signal.

An image signal obtaining section 16 reads, as an image signal, a charge signal accumulated in the image capture element. The image signal read by the image signal obtaining section 16 is output to a still image forming section 24 during capture of a still image, and to both the still image forming section 24 and a motion picture forming section 18 during capture of a motion picture. The reason why the image signal is output to both the still image preparation processing section and the motion picture preparation generation section during capture of a motion picture is because difference data, which will be described later, are generated for processing of generating a still image from a motion picture. The image signal output from the image signal obtaining section 16 corresponds to an image signal which is suitable for a still image and has a large number of pixels (e.g., 1920×1080 pixels), and is output at a frame rate (e.g., 30 frames/sec.) suited for a motion picture.

The image signal output from the image signal obtaining section 16 is output to both the still image forming section 24 and the motion picture forming section 18 during preparation of a motion picture. The motion picture forming section 18 additionally performs processing for scaling down an image. The term scale-down processing used herein signifies conversion of an original image into an image which is smaller than the original image in terms of the number of pixels (e.g., 1280×720 pixels), by means of skipping pixels or additionally performing interpolation as necessary.

In the motion picture forming section 18, the scaled-down image is, in unmodified form, subjected to image processing such as white balance processing, gamma correction processing, and distortion correction processing. In the still image forming section 24, the image output from the image obtaining section 16 is, in unmodified form, subjected to image processing mentioned above. In relation to image processing, the still image is subjected to image processing of higher accuracy. The image signal of high resolution formed in the still image forming section is temporarily stored in a still image storage buffer 26.

A difference/addition operation section 30 performs difference operation or addition operation of two images. Specifically, during capture of a motion picture, there is computed a difference between one frame of image of a motion picture to be described later and a still image captured at the same timing when the frame image is captured. The data obtained by the difference operation are stored as difference data into a storage device 34 such as a flash memory card or the like. When generation of a still image from a played-back motion picture is instructed, there is performed operation for adding the instructed frame image data to the difference data corresponding to the frame image data is performed, to thus generate a still image. The frame image of the motion picture has been scaled down, and the resolution of the frame image is smaller than that of the still image. Therefore, in operation for computing a difference between the frame image and the still image or operation for adding the frame image to the difference data, the frame image has been scaled-up in advance to the same size as that of the still image. Here, scale-up processing means conversion of an original image to an image, which is greater than the original image in terms of the number of pixels, by means of performing interpolation.

A JPEG processing section 28 encodes data into a JPEG format or decodes JPEG-encoded data into original data. Specifically, during capture of a still image or a motion picture, still image data or difference data are subjected to JPEG compression processing, and processed data are stored in a storage device. Further, during reproduction of an image, the image data stored in the storage device are subjected to JPEG decoding operation.

The image data formed by the motion picture forming section 18 are output to a tag-adding section 20 as a frame image constituting a motion picture. The tag-adding section 20 generates a tag image, and synthesizes the tag image with the frame image. Here, the tag image is an image showing an identification number assigned to each of frame images. Although details of the tag image will be described later, the tag image is an image used for identifying a frame image required to generate a still image from a motion picture.

An MPEG processing section 22 is for encoding an image into an MPEG 2 format or decoding an MPEG 2 image into an image. More specifically, when frame images given tags are sequentially input, the MPEG processing section 22 encodes the frame images into an MPEG 2 format, and stores the frame images as motion picture of MPEG 2 format into the storage device 34 such as a flash memory card memory or the like. Moreover, the MPEG processing section 22 also has a function of subjecting the motion picture data of MPEG 2 format to decoding processing during playback of a moving picture.

The index information forming section 32 prepares index information recording a relationship between respective frame images constituting a motion picture and corresponding difference data. The index information is formed from frame identification information output from the tag-adding section 20 and the difference data information output from the difference/addition operation section 30. The frame identification information includes a tag number indicated by the previously-described tag image and a number assigned to a GOP (a GOP number) to which the frame image pertains. Processing for generating a still image from a motion picture, which will be described later, is performed by reference to the index information. The thus-prepared index information is stored in the storage device 34 along with the motion picture.

When the user has given a corresponding image specifying section 38 an instruction for generating a still image from a motion picture by way of an operation section (not shown), the corresponding image specifying section 38 specifies the difference data corresponding to the frame image specified by the user. During specification of the difference data, reference is made to the index information stored in the storage device 34.

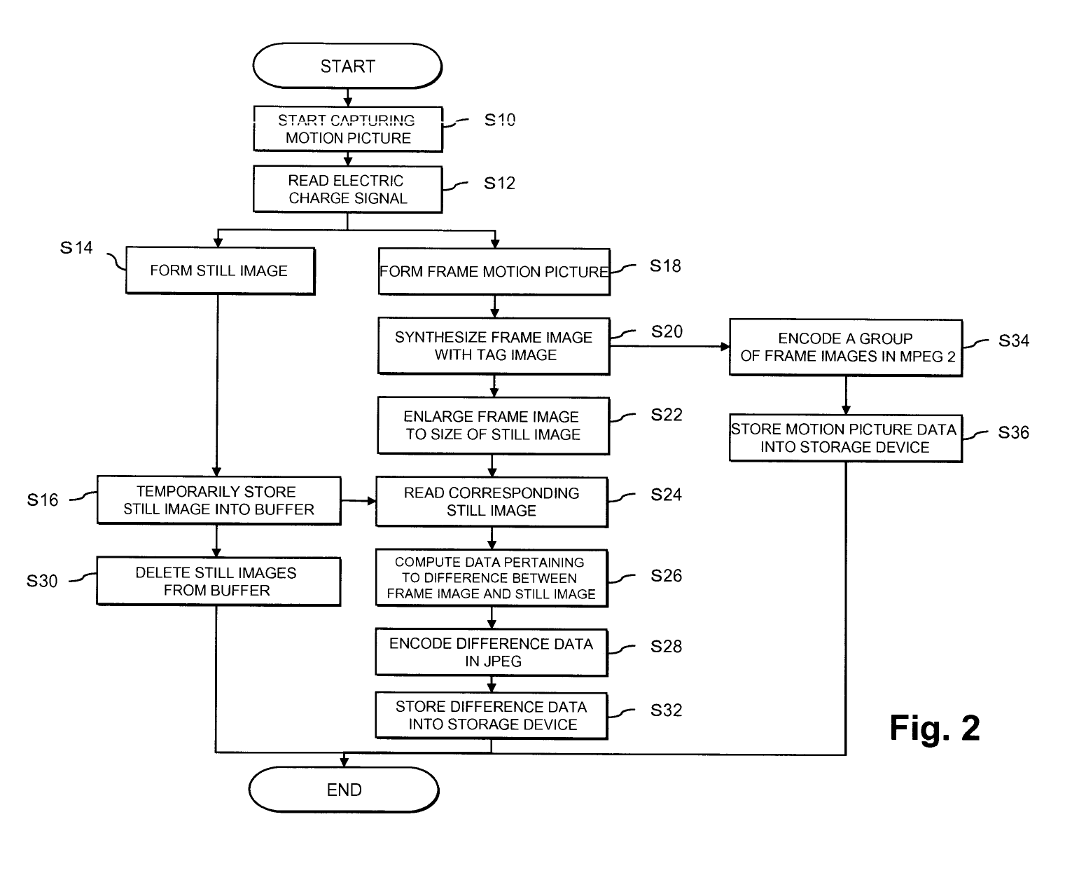

The flow of capture of a motion picture performed by the digital camera will now be described in detail. FIG. 2 is a flowchart showing the flow of capture of a motion picture.

Upon receipt of an instruction from the user for starting capture of a motion picture (S10), the image signal obtaining section 16 sequentially reads charge information, which is to be accumulated in the image capture element 14, at a predetermined frame rate, and outputs the charge information as an image signal (S12). The output image signal is input to the still image forming section 24 and the motion picture forming section 18. The still image forming section 24 subjects the thus-read image signal to various types of image processing suitable for a still image, and outputs the signal as still image data (S14). The output still image data are temporarily stored in the still image storage buffer (S16).

The motion picture forming section 18 subjects the thus-read image signal to various types of image processing, including scale-down processing, so that the image signal can be handled as one frame of image of the motion picture (S18). The frame image data having undergone image processing are input to the tag-adding section 20. The tag-adding section 20 generates a tag image, and synthesizes a corner of the input frame image with the tag image (S20).

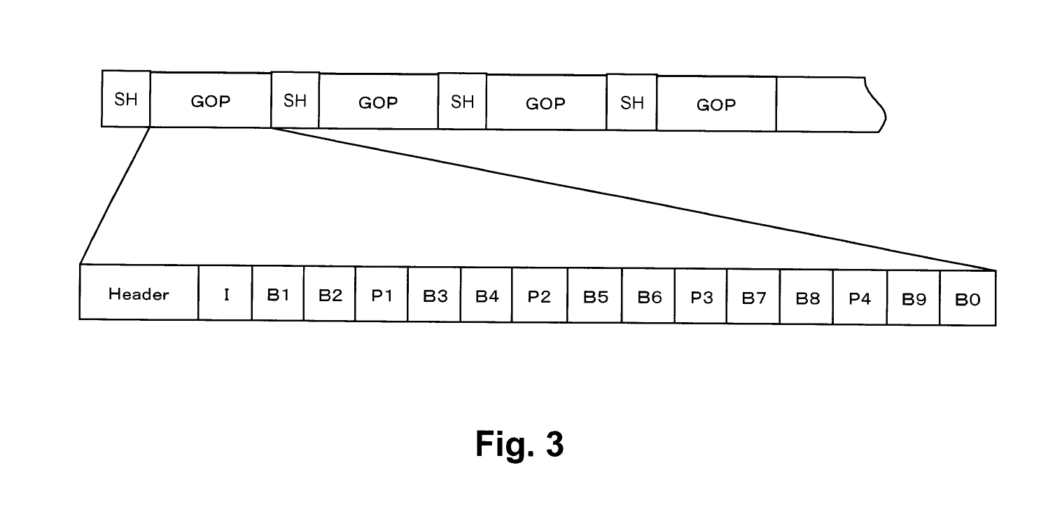

The reason why the tag image is added to the input frame image will be provided below. FIG. 3 is a view showing the hierarchical data structure of MPEG 2 data. As mentioned previously, the motion picture of this embodiment is stored in the MPEG 2 format. In the MPEG 2 format, a group GOP comprising frame images, each of which has a duration of 0.5 seconds (15 frames) or thereabouts, is taken a unit of management. Playback, a fast forward operation, or a rewind operation, which is performed from any point of a motion picture, is carried out on a per-GOP basis.

One of the GOPs includes at least one frame image called an I picture. This I picture is a frame which becomes a standard for compression processing. A single I picture forms compressed data which can be decoded. Meanwhile, a P picture is compressed data where a difference between an I picture of a frame preceding the corresponding frame (of the past) and the frame image of the P picture is recorded. A B picture is compressed data where there is recorded a difference between the frame of an I picture preceding the corresponding frame (of the past) and the frame of an I picture subsequent to the corresponding frame (of the future) or a difference between the frame of a P picture preceding the corresponding frame (of the past) and the frame of a P picture subsequent to the corresponding frame (of the future). When the frame image corresponding to the P picture and the frame image corresponding to the B picture are decoded, reference is made to the pictures for which the difference is recorded. For convenience of reference, the sequence of storage of the respective pictures (frames) in the GOP achieved during MPEG encoding operation is reverse to the sequence of playback.

Management information in a GOP unit is added as a header to the head of a GOP formed from three types of pictures. The motion picture is formed by consecutively arranging GOPs in sequence of playback. A sequence header SH, where management information about each GOP is stored, is added between respective GOPs.

Each of the GOPs can be readily identified by means of making reference to the header added to the top thereof. Meanwhile, a header is not added on a per-frame basis, and hence identification cannot be performed on a per-frame basis. However, when a still image is formed from a motion picture, a correspondence between each of the frame images and difference data can be ascertained, and, by extension, identification can be performed on a per-frame basis.

In the present embodiment, in order to effect identification on a per-frame basis, the tag-adding section 20 synthesizes each of the frame images with a tag image. The tag image is an image representing a tag number that is an identification number of a frame. The tag numbers may be embodied by serial numbers assigned to the top of motion pictures or serial numbers assigned to frame images in one GOP. When the serial numbers in one GOP are used as tag numbers, a GOP number recorded in the header of each of the GOPs and tag numbers synthesized with respective frames are used, to thus enable specification of a frame image. If the tag image is an image showing the tag number, the tag image may be materialized by a numeral of the tag number itself or a bar code into which a tag number is converted into an image by means of a predetermined algorithm.

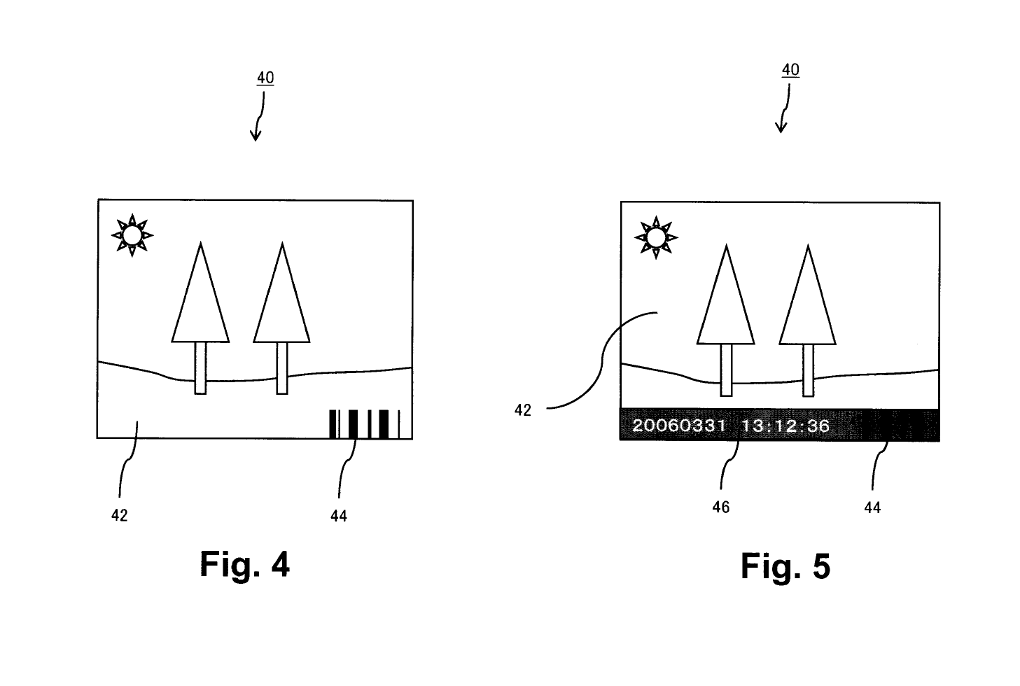

FIG. 4 is a drawing showing an example where a bar-coded tag image 44 is synthesized with a frame image 40. The tag image 44 differing from an original captured image 42 is preferably synthesized at a position where the tag image does not interfere with the captured image 42; e.g., the corner of the frame image 40 or the like. In order to make presence of the tag image less noticeable, another image may be added. For instance, as shown in FIG. 5, an image 46 showing a time code of color analogous to that of the tag image 44 may be added to the frame image 40, to thus synthesize the tag image 44 on the time code image 46. The tag image 44 is synthesized along with the other image 46 of analogous color, to thus render the tag image 44 less noticeable and diminish the sense of discomfort which the user feels when having viewed a played-back image. The present embodiment illustrates a bar code as the tag image 44. As a matter of course, a code of another type; e.g., a numerical image corresponding to an OCR, a gray code, a QR code, or the like, may be employed.

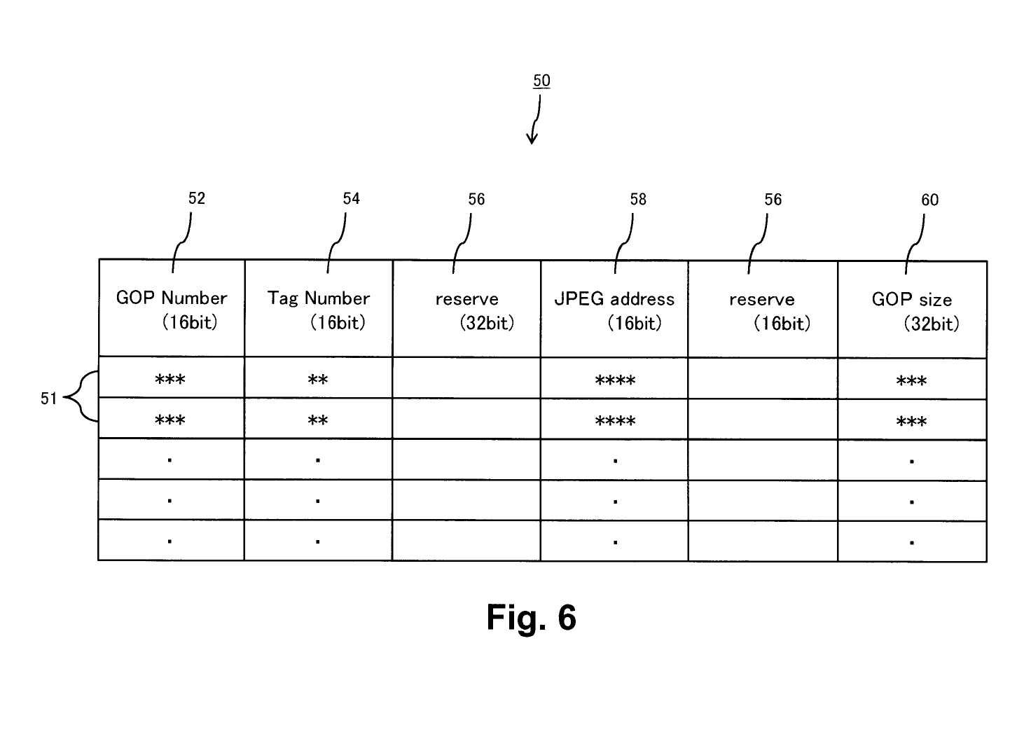

Turning back to FIG. 2, the flow of processing for capturing a motion picture will now be described. The frame image data synthesized with the tag image are output to both the difference/addition operation section 30 and the MPEG processing section 22. The difference/addition operation section 30 scales up the input frame image data to the size of a still image, and reads the still image data corresponding to the frame image data; i.e., the still image data captured at the same timing when the frame image is captured (S22, S24). Further, the difference/addition operation section 30 computes data pertaining to a difference between the still image data and the scaled-up frame image (S26). If the difference data are acquired, the difference/addition operation section 30 deletes the still image data stored in the still image storage buffer 26 (S30). The obtained difference data are output to the JPEG processing section 28. The JPEG processing section 28 converts the input difference data into data of JPEG format, and stores the thus-converted data into the storage device (S28, S32). At this time, identification information about the frame image that has become the source of difference data and the address of the difference data stored in the storage device are output to the index information preparation section 32. A GOP number, a tag number, and the size of the frame image correspond to the identification information about the frame image. FIG. 6 is a view showing example index information 50 prepared by the index information preparation section 32. In FIG. 6, the index information 50 corresponds to a string of records 51 formed for each frame. A GOP number 52 and a size 60, both pertaining to a GOP to which the corresponding frame image belongs, a tag number 54 of the frame, and address information 58 pertaining to difference data corresponding to the frame image are recorded in each of the records. A reserve area 56, which the user can freely use, is also ensured in each of the records. The index information preparation section 32 prepares such index information 50, and stores the thus-generated information into the storage device 34 as binary data.

In the meantime, the MPEG processing section 22 sequentially converts input frame image data into data of MPEG format (S34). The resultantly-obtained data are stored as a motion picture in the storage device 34 (S36).

As is evident from the above descriptions, according to the present embodiment, only the motion picture, the difference data, and the index information are stored finally in the storage device. The difference data are the respective pieces of frame image data and the data that are formed by extracting only the differences of the corresponding generated image data. The difference data is much smaller in volume than ordinary still image data. Consequently, when compared with a case where a motion picture and still image data are stored, required storage capacity can be reduced.

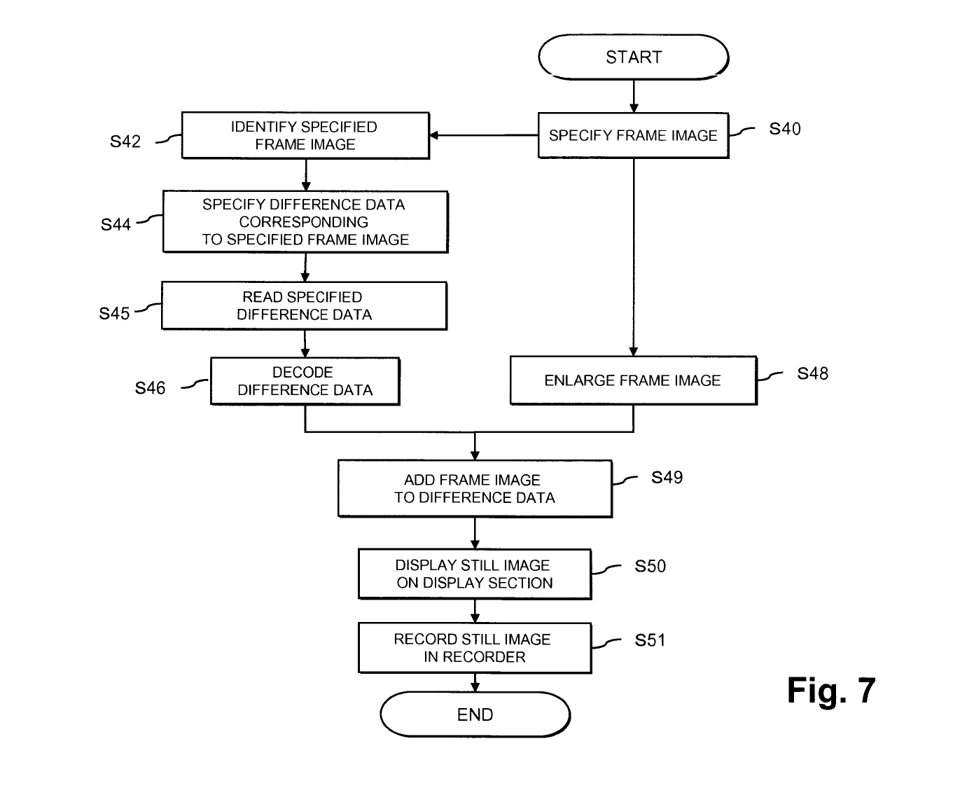

Flow of processing performed when the digital camera creates a still image from a motion picture will be described by reference to FIG. 7. When a still image is created from a motion picture, the user specifies a frame image, which is desired to be extracted as a still image, from a played-back motion picture (S40). Upon receipt of such specification, the corresponding image specifying section 38 of the digital camera identifies the frame image by means of the tag image synthesized with the specified frame image and the header information about a GOP to which the frame image belongs (S42).

The MPEG-decoded motion picture is provided with the header information on a per-GOP basis, and header information is not added on a per-frame basis. Put another way, identification information is not present on a per-frame basis in a common motion picture of MPEG format. Therefore, difficulty has hitherto been encountered in clearly distinguishing the frame image specified by the user. However, in the present embodiment, in order to distinguish a frame image, a tag image has been synthesized in advance. The corresponding image specifying section 38 recognizes the GOP number of the frame image by means of reading header information of the GOP to which the specified frame image belongs. The tag number of the frame image is recognized by means of interpreting the tag image synthesized to a predetermined position on the specified frame image. On the basis of the GOP number and the tag number, the frame image specified by the user is distinguished. Specifically, according to the embodiment where the tag image is synthesized to each of the frame images, identification can be performed not only on a per-GOP basis but also on a per-frame basis.

So long as the frame image can be identified, the corresponding image specifying section 38 refers to the index information stored in the storage device 34, thereby specifying the address of difference data corresponding to the frame image assigned the GOP number and the tag number (S44). The JPEG processing section 28 reads the difference data stored at the address specified by the corresponding image specifying section (S45), and performs processing for decoding the difference data (S46). The decoded difference data are output to the difference/addition operation section 30.

The difference/addition operation section 30 performs processing for scaling up the frame image specified by the user to the size of a still image, and also operation for adding the frame image to the decoded difference data (S48, S49). The difference/addition operation section 30 displays a result obtained through the addition operation on a display section 36 as a still image created from the motion picture (S50). After having ascertained the displayed image, the user stores the still image data into the storage device 34 when necessary (S51).

As is obvious from the above descriptions, according to the present embodiment, a tag image has been synthesized in advance with each of the frame images, and hence identification can be performed on a per-frame basis. Consequently, even when any frame has been specified, the frame can be identified without fail, and difference data corresponding to the frame can be specified accurately. As a result, a still image corresponding to the specified frame image can be created accurately.

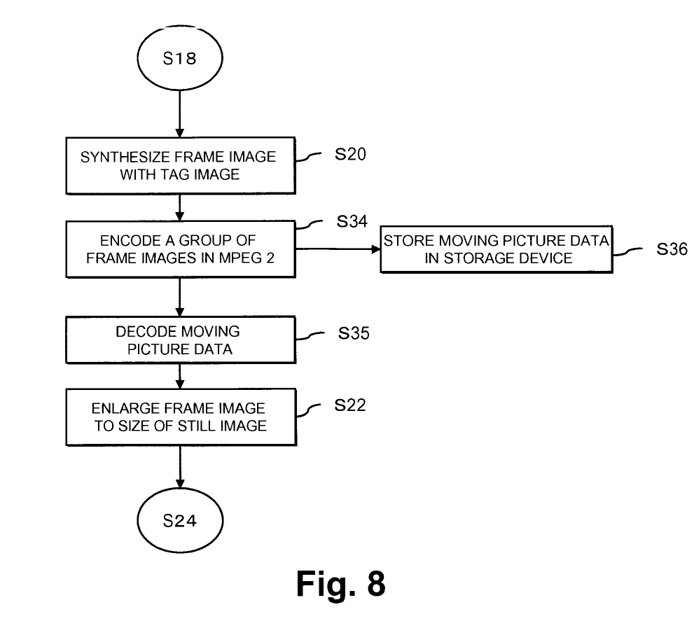

In the present embodiment, difference data are acquired before MPEG encoding operation. However, difference data may be computed after MPEG encoding operation. Specifically, as shown in FIG. 8, after a group of frame images have been subjected to MPEG encoding (S34), the encoded motion picture may be decoded (S35), and data pertaining to a difference between respective pieces of frame image data obtained through decoding and the still image data may be computed.

Although in the present embodiment the MPEG 2 format has been illustrated as a motion picture format, another motion picture format can be naturally applied, so long as the motion picture format poses difficulty in performance of identification on a per-frame basis.

Moreover, in the present embodiment, the index information is formed. However, difference data corresponding to each of the frame images may be specified without use of the index information. For instance, identification information about a corresponding frame image is recorded in the header of each of the pieces of difference data. Identification information recorded in the header and identification information indicated by a tag image synthesized with each of the frames may be checked against each other, to thus specify difference data.

The invention has been described in detail with particular reference to certain preferred embodiments thereof, but it will be understood that variations and modifications can be effected within the spirit and scope of the invention.

PARTS LIST

| | |
|---|---|
| 10 | digital camera |
| 12 | image capture optical system |
| 14 | image capturing element |
| 16 | image signal obtaining section |
| 18 | motion picture forming section |
| 20 | tag adding section |
| 22 | MPEG processing section |
| 24 | still image forming section |
| 26 | still image storage buffer |
| 28 | JPEG processing section |
| 30 | difference/addition computing section |
| 32 | index information preparation section |
| 34 | storage device |
| 36 | display section |
| 38 | corresponding image specifying section |
| 40 | frame image |
| 42 | original captured image |
| 44 | bar coded tag |
| 46 | image |
| 50 | index information |
| 51 | records |
| 52 | GOP number |
| 54 | tag number |
| 56 | reserve area |
| 58 | address information |
| 60 | GOP size |
| S10 | start capturing motion picture |
| S12 | read output charge signal |
| S14 | form still image |
| S16 | store still image in storage buffer |
| S18 | form frame motion picture |
| S20 | synthesize frame image with tag image |
| S22 | enlarge frame image to size of still image |
| S24 | read corresponding still image |
| S26 | compute data pertaining to difference |
| | between frame and still image |
| S28 | convert input difference data into JPEG format |
| S30 | delete still image from buffer |
| S32 | store converted data into storage device |
| S34 | convert input frame data into MPEG format |
| S35 | decode motion picture data |
| S36 | store motion picture data into storage device |
| S40 | specify frame image |
| S42 | identify specified frame image |
| S44 | specify difference data corresponding |
| | to specified frame image |
| S45 | read specified difference data |
| S46 | decode difference data |
| S48 | enlarge frame image |
| S49 | add frame image to difference data |
| S50 | display still image on display section |
| S51 | record still image in recorder |

1. An image capturing apparatus capable of creating a still image of high resolution corresponding to an arbitrary frame image among a plurality of frame images constituting a motion picture, the apparatus comprising;
image forming means for forming, from one image signal, frame images constituting the motion picture and a still image which is higher in resolution than the frame images;
identification image adding means for synthesizing to each of the formed frame images an identification image showing frame identification information used for identifying the frame image;
difference data forming means which acquires data pertaining to a difference between the frame image with which the identification image is synthesized and a still image corresponding to the frame image and which stores the difference data into storage means;
motion picture forming means which forms a motion picture on the basis of frame images with which an identification image is synthesized, and which stores the motion picture into the storage means; and
still image reconstructing means which specifies difference data corresponding to the specified frame image by reference to at least the frame identification information indicted by the identification image synthesized with the frame image, and which reconstructs a still image of high resolution on the basis of the frame image and the specified difference data.

2. The image capturing apparatus according to claim 1, wherein the identification image is a bar code formed by means of converting, into an image, a frame identification number used for identifying each of the frame images in accordance with a predetermined algorithm.

3. The image capturing apparatus according to claim 1 or 2, wherein the identification image is synthesized with a corner of each of the frame images.

4. The image capturing apparatus according to any one of claims 1 to 3, wherein the identification image is synthesized with the frame image along with another image which is analogous in color to the identification image.

5. The image capturing apparatus according to any one of claims 1 to 4, wherein the motion picture forming means forms a motion picture at a motion picture format by means of which header information is not added to each frame.

6. The image capturing apparatus according to claim 5, wherein the motion picture forming means forms a motion picture in an MPEG 2 format.

7. The image capturing apparatus according to any one of claims 1 to 6, further comprising:
index information forming means which forms index information for recording in an associated manner at least frame identification information showing an identification image synthesized with each of the frame images and identification information about differential data, wherein
the still image reconstructing means specifies difference data corresponding to the specified frame image by reference to the index information.

8. The image capturing apparatus according to claim 7, wherein, when a motion picture corresponds to data formed by sequentially arranging frame group, each of which is formed from a plurality of frame images, index information is information formed by recording in an associated manner group identification information about a frame group to which each of frame images pertains, frame identification information indicated by an identification image synthesized with the frame image, and an address of difference data corresponding to the frame image.

9. An image capturing apparatus for generating a motion picture from a plurality of frame images, the apparatus comprising:
identification image adding means for synthesizing, before a motion picture is subjected to encoding processing, each of frame images constituting a motion picture with an identification image showing frame identification information used for identifying the frame image; and
identification means for identifying each of the frame images in accordance with at least frame identification information showing an identification image synthesized to each of the frame images.
